(19) United States
(12) Patent Application Publication
(10) Pub. No.: US 2025/0389494 A1
(43) Pub. Date: Dec. 25, 2025

(54) COOLING DEVICE AND METHOD FOR MANUFACTURING COOLING DEVICE

(71) Applicant: TOYOTA JIDOSHA KABUSHIKI KAISHA, Toyota-shi (JP)

(72) Inventor: Osamu Yamashita, Toyota-shi (JP)

(73) Assignee: TOYOTA JIDOSHA KABUSHIKI KAISHA, Toyota-shi (JP)

(21) Appl. No.: 19/040,161

(22) Filed: Jan. 29, 2025

(30) Foreign Application Priority Data
Jun. 25, 2024 (JP) 2024-101680

(51) Int. Cl. F28F 1/40; B23P 15/26

(52) U.S. Cl. CPC F28F 1/40; B23P 15/26

(57) ABSTRACT

The cooling device according to the present disclosure includes an exterior portion having a flat cooling surface on the front and back sides thereof, and a deformation suppressing portion housed in the interior of the exterior portion and suppressing deformation of the exterior portion. The exterior portion and the deformation suppressing portion are one metal member having a first bent structure at a boundary between a front side portion of the exterior portion and the deformation suppressing portion, and having a second bent structure at a boundary between a back side portion of the exterior portion and the deformation suppressing portion.

### CROSS-REFERENCE TO RELATED APPLICATION

This application claims priority to Japanese Patent Application No. 2024-101680 filed on Jun. 25, 2024. The disclosure of the above-identified application, including the specification, drawings, and claims, is incorporated by reference herein in its entirety.

### BACKGROUND

### 1. Technical Field

The present disclosure relates to a cooling device and a method for manufacturing the cooling device.

### 2. Description of Related Art

Japanese Unexamined Patent Application Publication No. 2023-011369 (JP 2023-011369 A) describes a cooling device and a method for manufacturing the cooling device. The method for manufacturing the cooling device described in JP 2023-011369 A includes a step of forming a flow path of a coolant and a substrate, a bending step of bending the substrate, and a welding step of performing laser welding.

### SUMMARY

The cooling device described in JP 2023-011369 A is a cooling device having a cooling surface on only one side, but a cooling device having cooling surfaces on both sides is also known. When the cooling surfaces are provided on both sides, there is a problem that the number of members of the exterior portion of the cooling device increases, and accordingly, the manufacturing cost increases. JP 2023-011369 A does not disclose a technology capable of solving such a problem.

The present disclosure has been made to solve such a problem, and an object thereof is to provide a cooling device capable of reducing a manufacturing cost and a method for manufacturing the cooling device.

A cooling device according to the present disclosure includes:
an exterior portion including flat cooling surfaces on front and back sides; and
a deformation suppressing portion that is housed inside the exterior portion and suppresses deformation of the exterior portion.
The exterior portion and the deformation suppressing portion are a single metal member including a first bent structure at a boundary between a front side portion of the exterior portion and the deformation suppressing portion, and a second bent structure at a boundary between a back side portion of the exterior portion and the deformation suppressing portion.

In such a configuration, the cooling device according to the present disclosure can be manufactured from the single metal member. As a result, the manufacturing cost can be reduced.

In the cooling device according to the present disclosure,
edges of the exterior portion may be welded over an entire circumference.
In such a configuration, the edges of the exterior portion are appropriately sealed. Therefore, the cooling device according to the present disclosure can suppress the leakage of the coolant.

In the cooling device according to the present disclosure,
the exterior portion and the deformation suppressing portion may include substantially point-symmetrical cross sections.
In such a configuration, the cooling device according to the present disclosure can be manufactured using a mold having a simple configuration. As a result, the manufacturing cost can be reduced.

In a method for manufacturing a cooling device according to the present disclosure,
the cooling device includes:
   an exterior portion including flat cooling surfaces on front and back sides; and
   a deformation suppressing portion that is housed inside the exterior portion and suppresses deformation of the exterior portion.
The method for manufacturing the cooling device includes a press-forming step and a bending step.
The press-forming step is a step of press-forming a front side portion and a back side portion of the exterior portion and the deformation suppressing portion on a metal plate. The bending step is a step of bending the press-formed metal plate at a boundary between the front side portion and the deformation suppressing portion and at a boundary between the back side portion and the deformation suppressing portion to house the deformation suppressing portion in the exterior portion.

In such a configuration, in the method for manufacturing the cooling device according to the present disclosure, the exterior portion and the deformation suppressing portion of the cooling device can be formed by processing the single metal plate. As a result, the method for manufacturing the cooling device according to the present disclosure can reduce the manufacturing cost of the cooling device.

In the method for manufacturing the cooling device according to the present disclosure,
the press-forming step may include:
   a first press-forming step; and
   a second press-forming step.
The first press-forming step may be a step of forming one of the front side portion and the back side portion and part of the deformation suppressing portion.
The second press-forming step may be a step of press-forming the other of the front side portion and the back side portion and part of the deformation suppressing portion with a mold used in the first press-forming step.
In such a configuration, the method for manufacturing the cooling device according to the present disclosure can simplify the configuration of the mold to be used for press forming. As a result, the method for manufacturing the cooling device according to the present disclosure can further reduce the manufacturing cost of the cooling device.

According to the present disclosure, it is possible to provide the cooling device capable of reducing the manufacturing cost and the method for manufacturing the cooling device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a configuration of a cooling device according to a first embodiment;

FIG. 2A is a top view illustrating a configuration of a cooling device according to a first embodiment;

FIG. 2B is a cross-sectional view illustrating a configuration of a cooling device according to a first embodiment;

FIG. 2C is a cross-sectional view illustrating a configuration of a cooling device according to a first embodiment;

FIG. 3 is a flowchart illustrating a configuration of a method for manufacturing a cooling device according to the first embodiment;

FIG. 4A is a top view for explaining a configuration of a manufacturing process of a cooling device according to a first embodiment;

FIG. 4B is a cross-sectional view illustrating a configuration of a method for manufacturing a cooling device according to a first embodiment;

FIG. 5A is a cross-sectional view for explaining a configuration of a method for manufacturing a cooling device according to a first embodiment; and

FIG. 5B is a cross-sectional view for explaining a configuration of a method for manufacturing a cooling device according to a first embodiment.

### DETAILED DESCRIPTION OF EMBODIMENTS

### First Embodiment

### Cooling Device Configuration

Hereinafter, a first embodiment according to the present disclosure will be described in detail with reference to the drawings. First, the configuration of the cooling device according to the present embodiment will be described in detail.

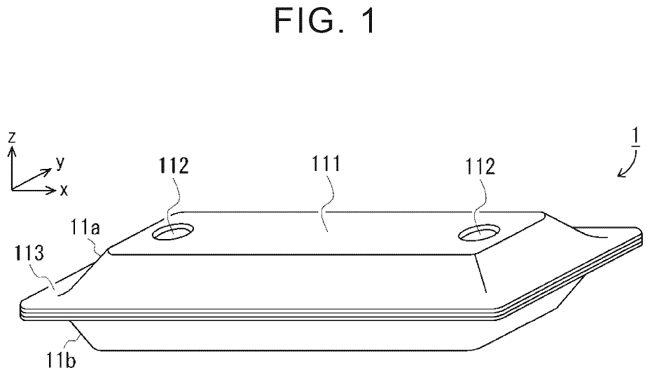

FIG. 1 is a perspective view illustrating a configuration of a cooling device according to a first embodiment.

It should be understood that the right-hand xyz orthogonal coordinates illustrated in FIG. 1 and the other drawings are for convenience of describing the positional relation of the constituent elements, and are the same among the drawings.
In addition, the scale of FIG. 1 and other drawings may be different from each other.

The cooling device 1 is a device used for cooling an object to be cooled. More specifically, the cooling device 1 cools the cooling surface of the apparatus exterior by the coolant flowing inside the apparatus. Then, the cooled cooling surface comes into contact with the object to be cooled, and as a result, the object to be cooled is cooled.

The object to be cooled may be any object having a shape capable of contacting the cooling surface of the cooling device 1, for example, the object to be cooled is a power storage module.

As shown in FIG. 1, the cooling device 1 according to the present embodiment is a plate-shaped device having a substantially rectangular upper surface when viewed from the z-axis direction. The cooling device 1 has cooling surfaces on both sides viewed from the positive direction and the negative direction of the z-axis.

In the following description, for clarity of explanation, the surface of the cooling device 1 as viewed from the positive direction of the z-axis is referred to as a surface, and the surface of the cooling device 1 as viewed from the negative direction of the z-axis may be referred to as a back surface. It should be understood that these designations are merely for convenience and are not intended to limit the arrangement direction, other configurations, and the like when the cooling device 1 is used. The same applies to the front side portion 11a and the back side portion 11b, which will be described later.

For example, the cooling device 1 may be disposed in a gap between the power storage modules in the power storage device including the plurality of power storage modules. In such a case, the cooling device 1 can cool the plurality of power storage modules at the same time by using the cooling surfaces provided on the front surface and the back surface.

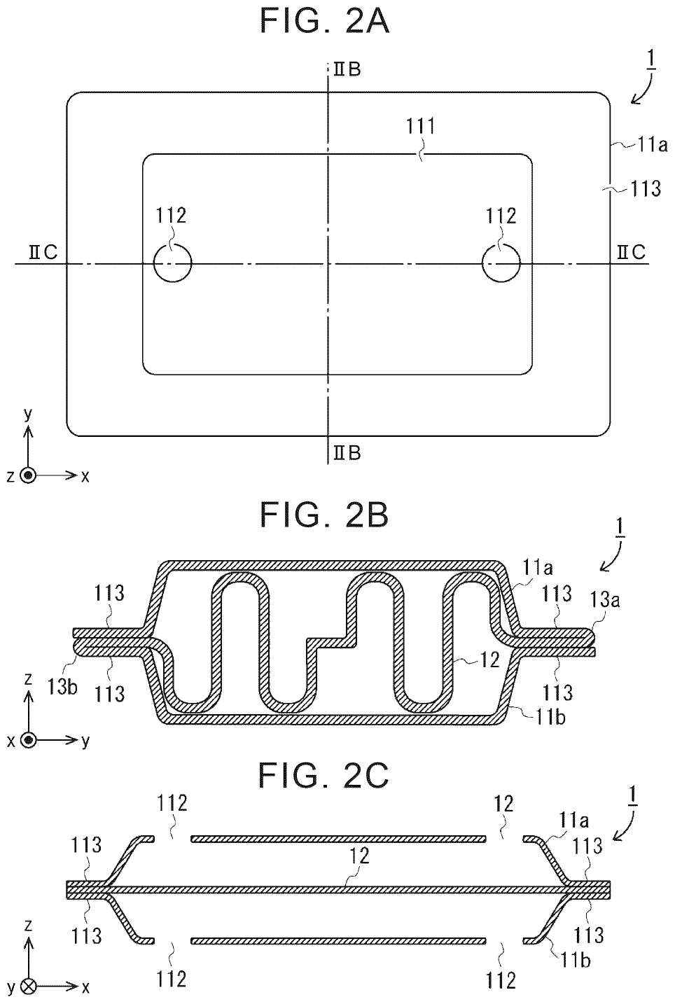

FIG. 2A is a top view illustrating a configuration of a cooling device according to a first embodiment. FIGS. 2B and 2C are cross sectional views showing the composition of the cooling device concerning a first embodiment More specifically, FIG. 2A is a top view of the cooling device 1 viewed from the positive z-axis. Further, FIG. 2B is a cross-sectional view of the cooling device 1 when the cooling device 1 is cut along IIB-IIB line shown in FIG. 2A. Further, FIG. 2C is a cross-sectional view of the cooling device 1 when the cooling device 1 is cut along IIC-IIC line shown in FIG. 2A.

As shown in FIGS. 2B and 2C, the cooling device 1 includes an exterior portion 11 having a flat cooling surface 111 on both surfaces, and a deformation suppressing portion 12 accommodated in the interior of the exterior portion 11 and suppressing deformation of the exterior portion 11.

The exterior portion 11 is a box-shaped metal member having a flat cooled surface on both sides and having an inner space, and is composed of a front side portion 11a and a back side portion 11b which are plate-shaped portions each having a concave structure. The inner space of the exterior portion 11 is formed by combining the recessed features of the front side portion 11a and the back side portion 11b.

The deformation suppressing portion 12 is accommodated in the internal space of the exterior portion 11. In other words, the exterior portion 11 houses the deformation suppressing portion 12.

The exterior portion 11 is supported from the inside by the deformation suppressing portion 12. Therefore, deformation of the exterior portion 11 is suppressed even when excessive force is applied from the outside.

In addition, the internal space of the exterior portion 11 functions as a flow path for the coolant. The coolant flowing through the internal space cools the cooling surface 111 provided in the exterior portion 11, and the cooling surface 111 cooled by the coolant cools the object to be cooled which is in contact with the cooling surface 111. That is, the coolant flowing through the internal space indirectly cools the object to be cooled via the cooling surface 111.

As the coolant, for example, water, an antifreeze, or the like can be used, but any liquid may be used as long as it is a liquid that is generally used as a coolant.

The front side portion 11a and the back side portion 11b each include a cooling surface 111, a coolant hole portion 112, and an edge 113.

Note that, as described above, the designation of the front side portion 1la and the back side portion 11b is merely a convenience designation for clarity of explanation, and is not intended to limit the arrangement direction when the cooling device 1 is used, the configuration, and the like in any way.

The cooling surface 111 is a flat surface corresponding to the bottom surface of the concave structure of the front side portion 11a and the back side portion 11b, and is supported by the deformation suppressing portion 12 from the inside of the cooling device 1.

The cooling surface 111 is cooled by the coolant flowing through the internal space. The cooled cooling surface 111 comes into contact with the object to be cooled on the outside of the cooling device 1, and cools the object to be cooled.

The cooling surface 111 according to the present embodiment is connected to the edge 113 via an inclined connection surface. According to such a configuration, it is possible to suppress occurrence of a molding defect during molding of the cooling surface 111. However, the configuration of the cooling surface 111 according to the present disclosure is not limited to this, and may be connected to the edge 113 via a surface perpendicular to the cooling surface 111, for example.

The coolant hole portion 112 is a hole provided in the cooling surface 111, and functions as an injection hole or a discharge hole of the coolant. Two coolant hole portions 112 are provided for one cooling surface 111, one of which functions as a coolant injection hole, and the other of which functions as a coolant discharge hole.

However, in the cooling device 1 according to the present disclosure, a position where the coolant hole portion 112 can be provided is not limited to the cooling surface 111.

The coolant hole portion 112 may be provided in any position as long as the coolant can be injected or discharged into the cooling device 1, and for example, the coolant hole portion 112 may be provided on a surface connecting the cooling surface 111 and the edge 113.

The coolant flows into the internal space of the cooling device 1 from the coolant hole portion 112 functioning as an injection hole, and cools the cooling surface 111 from the inside. The coolant having cooled the cooling surface 111 flows out from the coolant hole portion 112 functioning as a discharge hole.

In use of the cooling device 1, a coolant injection member or a coolant discharge member (not shown) is attached to the coolant hole portion 112. For example, each of the injection member and the discharge member includes a pipe that serves as a flow path for the coolant, and a fixture that fixes the pipe to the coolant hole portion 112.

The edge 113 is an edge-like portion located at the outer edge of the concave structure of the front side portion 11a and the back side portion 11b. The edge 113 on the front side portion 11a and the edge 113 on the back side portion 11b are welded via the deformation suppressing portion 12.

As will be described later, the front side portion 1la and the back side portion 11b each include bent structures 13a and 13b on one side of the edge 113.

The edge 113 may be welded over the entire circumference. In other words, the edge 113 may be welded in an O-shape.

According to such a configuration, since the edge 113 of the exterior portion 11 is appropriately sealed, the cooling device 1 can suppress the leakage of the coolant from the edge 113.

The deformation suppressing portion 12 is housed inside the exterior portion 11, and suppresses deformation of the exterior portion 11. As shown in FIG. 2B, the deformation suppressing portion 12 according to the present embodiment is a metal member having a corrugated cross section, and the linear concavo-convex structure extends parallel to the x-axis direction.

The deformation suppressing portion 12 is in contact with the inner portion of the exterior portion 11 in the vicinity of each apex of the uneven structure, and supports the cooling surface 111 from the inner side of the exterior portion 11. With such a configuration, the deformation suppressing portion 12 suppresses deformation of the exterior portion 11.

In addition, the deformation suppressing portion 12 divides the internal space of the exterior portion 11 in a line shape parallel to the x-axis, and also functions as a flow path for facilitating the flow of the coolant flowing in the internal space from the injection hole to the discharge hole.

Therefore, the uneven structure of the deformation suppressing portion 12 is preferably present only in a portion corresponding to the gap between the two coolant hole portions 112 of one cooling surface 111. According to such a configuration, all the internal spaces divided by the deformation suppressing portion 12 are filled with the coolant injected from the coolant hole portion 112. As a result, the cooling device 1 can cool the object to be cooled more efficiently.

As described above, the deformation suppressing portion 12 according to the present embodiment is a metal member having a corrugated cross section, and the linear uneven structure extends parallel to the x-axis direction, but the shape of the deformation suppressing portion 12 according to the present disclosure is not limited thereto. For example, the deformation suppressing portion 12 may have a zigzag cross-section or a pulse waveform cross-section.

That is, the deformation suppressing portion 12 may have any shape as long as it supports the exterior portion 11 from the inside and can control the flow of the coolant in one direction.

Here, the exterior portion 11 and the deformation suppressing portion 12 according to the present embodiment are one metal member. The exterior portion 11 and the deformation suppressing portion 12 according to the present embodiment have a first bent structure 13a at the boundary between the front side portion 1la of the exterior portion 11 and the deformation suppressing portion 12. The exterior portion 11 and the deformation suppressing portion 12 according to the present embodiment have a second bent structure 13b at the boundary between the back side portion 11b of the exterior portion 11 and the deformation suppressing portion 12.

More specifically, the exterior portion 11 and the deformation suppressing portion 12 according to the present embodiment are formed of one metal plate bent so as to have a z-shaped cross section.

The front side portion 11a and the deformation suppressing portion 12 are formed as a series of metal members with one side of the cooling device 1 as a boundary, and have a first bent structure 13a at the boundary.
Further, the back side portion 11b and the deformation suppressing portion 12 are configured as a series of metal members with one side of the cooling device 1 as a boundary, and have a second bent structure 13b at the boundary.

With such a configuration, the cooling device 1 according to the present embodiment can manufacture the exterior portion 11 and the deformation suppressing portion 12 from a single metal plate. As a result, the cooling device 1 according to the present embodiment can reduce the manufacturing cost.

As described above, the cooling device 1 according to the present embodiment includes the exterior portion 11 having the flat cooling surface 111 on both surfaces, and a deformation suppressing portion accommodated in the interior of the exterior portion 11 and suppressing deformation of the exterior portion 11. The exterior portion 11 and the deformation suppressing portion 12 are each formed of a metal member at a position, and have bent structures at a boundary between the front side portion 11a and the deformation suppressing portion 12 and a boundary between the back side portion 11b and the deformation suppressing portion 12.

With such a configuration, the cooling device 1 according to the present embodiment can be manufactured from one metal member, and as a result, the manufacturing cost can be suppressed.

Further, in the cooling device 1 according to the present embodiment, the edge 113 of the exterior portion 11 is welded over the entire circumference. With such a configuration, the cooling device 1 according to the present embodiment can suppress leakage of the coolant.

Cooling device and method of manufacturing the same

Next, a method of manufacturing the cooling device according to the first embodiment will be described in detail.

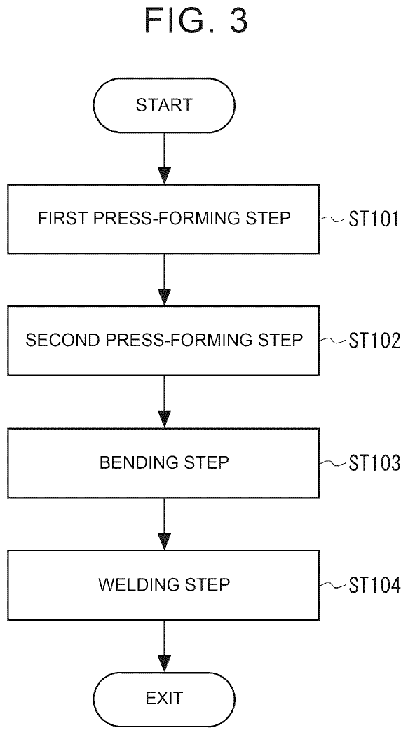

FIG. 3 is a flowchart illustrating a method of manufacturing the cooling device according to the first embodiment.

As shown in FIG. 3, the manufacturing process of the cooling device according to the present embodiment includes a first press-forming step ST101, a second press-forming step ST102, a bending step ST103, and a welding step ST104.

The first press-forming step ST101 and the second press-forming step ST102 may be collectively referred to as a press-forming step. The welding step ST104 can also be replaced by other processes for bonding the metal.

Therefore, it can be said that the method for manufacturing the cooling device according to the present embodiment only needs to include a press-forming step and a bending step.

In the manufacturing process of the cooling device according to the present embodiment, first, the first press-forming step ST101 and the second press-forming step ST102 are executed.

In the first press-forming step ST101 and the second press-forming step ST102, that is, in the press-forming step, the front side portion 11a and the back side portion 11b of the exterior portion 11 and the deformation suppressing portion 12 are press-molded with respect to the metal plate.

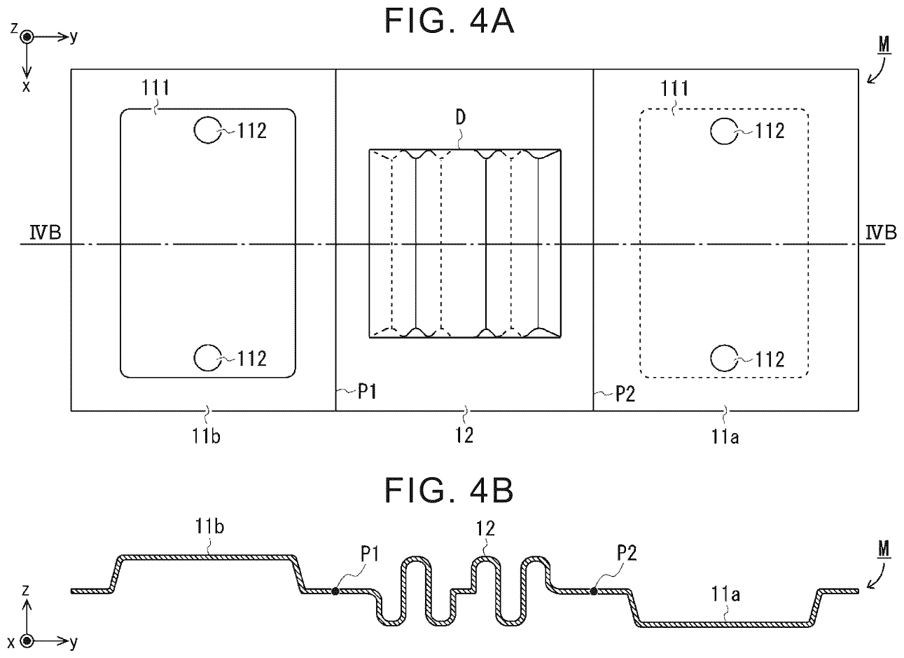

FIG. 4A is a top view for explaining a manufacturing process of the cooling device according to the first embodiment. FIG. 4B is a cross-sectional view illustrating a method for manufacturing a cooling device according to a first embodiment of the present disclosure.

More specifically, FIG. 4A is a top view of the metal plate M after the first press-forming step ST101 and the second press-forming step ST102 are performed when viewed from the positive z-axis.
Further, FIG. 4B is a cross-sectional view of the metal plate M after the first press-forming step ST101 and the second press-forming step ST102 are performed, taken along IVB-IVB line shown in FIG. 4A.

Note that a solid line indicating the cooling surface 111 of the back side portion 11b described in FIG. 4A means that the cooling surface 111 of the back side portion 11b is located on the front side of the z-axis with respect to the paper surface. Further, a broken line indicating the cooling surface 111 of the front side portion 11a described in FIG. 4A means that the cooling surface 111 of the back side portion 11b is located on the z-axis negative side of the paper surface.

Further, reference numeral D attached to the inside of the deformation suppressing portion 12 described in FIG. 4A indicates an area where the above-described uneven structure exists in the deformation suppressing portion 12. A solid line in the region D illustrates an uneven structure located on the positive side of the z-axis with respect to the plane of the drawing. A broken line in the region D illustrates a concavo-convex structure located on the positive-negative side of the z-axis relative to the plane of the drawing.

As shown in FIGS. 4A and 4B, the metal plate after the first press-forming step ST101 and the second press-forming step ST102 is molded in the order described, the back side portion 11b, the deformation suppressing portion 12, and the front side portion 1la.

Here, a boundary Pl between the back side portion 11b and the deformation suppressing portion 12 and a boundary P2 between the front side portion 11a and the deformation suppressing portion 12 are set in the metal plate M.

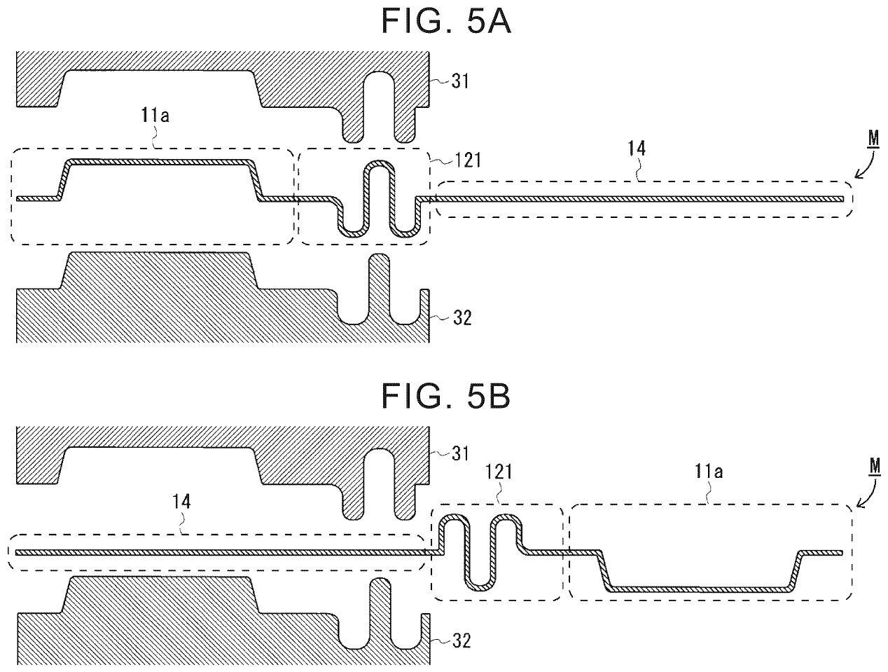

FIGS. 5A and 5B are cross-sectional views for explaining the press-forming step according to the first embodiment. More specifically, FIG. 5A is a cross-sectional view showing the metal plate M immediately after the first press-forming step ST101 is performed and the press-molding device. FIG. 5B is a cross-sectional view showing a metal plate M immediately before performing the second press-forming step ST102, and a press molding device.

The first press-forming step ST101 according to the present embodiment is performed by pressing the metal plate M by a press-molding device having the female mold 31 and the male mold 32.

As shown in FIG. 5A, in the press-forming step ST101, only a part of the metal plate M is pressed, and the front side portion 1la and the half deformation suppressing portion 121 which is a part of the deformation suppressing portion 12 are press-molded.
That is, the first press-forming step ST101 according to the present embodiment is a step of molding one of the front side portion 1la and the back side portion 11b and a part of the deformation suppressing portion 12.
Here, immediately after the first press-forming step ST101 is performed, the metal plate M has a pre-processing planar portion 14 which is a planar portion which is not press-molded.

The second press-forming step ST102 according to the present embodiment is executed by pressing the pre-processing planar portion 14 of the metal plate M by the press-molding device having the female mold 31 and the male mold 32 used in the first press process.

As shown in FIG. 5B, in the press-forming step ST102, first, the front and rear surfaces of the metal plate M press-molded in the first press-forming step ST101 are turned upside down, and the pre-processing planar portion 14 is set in the female mold 31 and the male mold 32. Then, by pressing by the female mold 31 and the male mold 32, the back side portion 11b and the remaining part of the deformation suppressing portion 12 are molded on the metal plate M.
That is, the second press-forming step ST102 according to the present embodiment is a step of molding one of the front side portion 11a and the back side portion 11b and a part of the deformation suppressing portion 12.

As described above, in the press-forming step according to the present embodiment, the first press-forming step ST101 and the second press-forming step ST102 are performed in two stages, whereby the configuration of the mold can be simplified. As a result, the manufacturing method of the cooling device according to the present embodiment can suppress the manufacturing cost of the cooling device.

Note that in the press-forming step, in order to perform two steps of the first press-forming step ST101 and the second press-forming step ST102, the exterior portion 11 and the deformation suppressing portion 12 need to have a substantially point-symmetrical cross section. Therefore, in the cooling device 1 according to the present embodiment, it is preferable that the exterior portion 11 and the deformation suppressing portion 12 have substantially point-symmetrical cross sections.

FIG. 3, FIG. 4A and FIG. 4B are described again.

As shown in FIG. 3, in the manufacturing process of the cooling device according to the present embodiment, the bending step ST103 is executed after the second press-forming step

ST102 is executed.

In the bending step ST103, the press-molded metal plate M is bent at the boundary P1 between the front side portion 11a and the deformation suppressing portion 12 and at the boundary P2 between the back side portion 11b and the deformation suppressing portion 12, thereby accommodating the deformation suppressing portion 12 in the exterior portion 11.

More specifically, in the bending step ST103 according to the present embodiment, first, the metal plate M is bent so that the back side portion 11b rotates in a half-clockwise direction with the boundary PI as an axis, and the deformation suppressing portion 12 is accommodated in the concave structure of the back side portion 11b.

Next, with the boundary P2 as an axis, the metal plate M is bent so that the front side portion 11a rotates clockwise, and the deformation suppressing portion 12 is accommodated in the concave structure of the front side portion 11a. By this step, the exterior portion 11 is formed while the deformation suppressing portion 12 is accommodated.
It should be understood that the order of bending of the boundary PI and the order of bending of the boundary P2 may be reversed.

In the manufacturing process of the cooling device according to the present embodiment, finally, the welding step ST104 is performed. In the welding step ST104, the edge 113 on the front side portion 11a and the edge 113 on the back side portion 11b are welded via the deformation suppressing portion 12, thereby completing the cooling device 1.

As described above, in the welding step ST104 according to the present embodiment, the edge 113 is preferably welded over the entire circumference.

As described above, the manufacturing process of the cooling device according to the present embodiment includes a step of press-molding the front side portion 11a and the back side portion 11b of the exterior portion 11 and the deformation suppressing portion 12 with respect to the metal plate M, and a step of accommodating the deformation suppressing portion 12 in the exterior portion 11 by bending the press-molded metal plate M at the boundary P2 between the front side portion 11a and the deformation suppressing portion 12 and the boundary PI between the back side portion 11b and the deformation suppressing portion 12.

According to such a configuration, in the method of manufacturing the cooling device according to the present embodiment, the exterior portion 11 and the deformation suppressing portion 12 of the cooling device 1 can be formed by processing one metal plate. As a result, the manufacturing method of the cooling device according to the present embodiment can suppress the manufacturing cost of the cooling device 1.

Further, in the method for manufacturing a cooling device according to the present embodiment, the press-forming step includes a first press-forming step and a second press-forming step. In the second press-forming step, the mold used in the first press step is used.

According to such a configuration, the manufacturing method of the cooling device according to the present embodiment can simplify the configuration of the mold used for press molding. As a result, the manufacturing method of the cooling device according to the present disclosure can further reduce the manufacturing cost of the cooling device 1.

Although the present disclosure has been described with reference to the above embodiments, it is to be understood that the disclosure is not limited only to the configuration of the above embodiments, but also includes various modifications, modifications, and combinations that may be made by a person skilled in the art within the scope of the claimed disclosure of the claims of the present application.

What is claimed is:

1. A cooling device comprising:
an exterior portion including flat cooling surfaces on front and back sides; and
a deformation suppressing portion that is housed inside the exterior portion and suppresses deformation of the exterior portion, wherein
the exterior portion and the deformation suppressing portion are a single metal member including a first bent structure at a boundary between a front side portion of the exterior portion and the deformation suppressing portion, and a second bent structure at a boundary between a back side portion of the exterior portion and the deformation suppressing portion.

2. The cooling device according to claim 1, wherein edges of the exterior portion are welded over an entire circumference.

3. The cooling device according to claim 1, wherein the exterior portion and the deformation suppressing portion include substantially point-symmetrical cross sections.

4. A method for manufacturing a cooling device, the cooling device including:
an exterior portion including flat cooling surfaces on front and back sides; and
a deformation suppressing portion that is housed inside the exterior portion and suppresses deformation of the exterior portion,
the method comprising:
a press-forming step of press-forming a front side portion and a back side portion of the exterior portion and the deformation suppressing portion on a metal plate; and
a bending step of bending the press-formed metal plate at a boundary between the front side portion and the deformation suppressing portion and at a boundary between the back side portion and the deformation suppressing portion to house the deformation suppressing portion in the exterior portion.

5. The method according to claim 4, wherein the press-forming step includes:
a first press-forming step of forming one of the front side portion and the back side portion and part of the deformation suppressing portion; and
a second press-forming step of press-forming the other of the front side portion and the back side portion and part of the deformation suppressing portion with a mold used in the first press-forming step.
